(19) United States
(12) Patent Application Publication
(10) Pub. No.: US 2025/0369264 A1
(43) Pub. Date: Dec. 4, 2025

(54) MOTOR VEHICLE LOCK, IN PARTICULAR MOTOR VEHICLE DOOR LOCK

(71) Applicant: Kiekert Aktiengesellschaft, Heiligenhaus (DE)

(72) Inventors: Michael SCHOLZ, Essen (DE); Thorsten BENDEL, Oberhausen (DE)

(73) Assignee: Kiekert Aktiengesellschaft, Heiligenhaus (DE)

(21) Appl. No.: 18/876,756

(22) PCT Filed: May 24, 2023
(86) PCT No.: PCT/DE2023/100387

§ 371 Date: Dec. 19, 2024

(30) Foreign Application Priority Data
Jul. 1, 2022 (DE) 10 2022 116 529.9

(51) Int. Cl. E05B 81/08; E05B 81/30; E05B 81/74

(52) U.S. Cl. CPC E05B 81/08; E05B 81/30; E05B 81/74

(57) ABSTRACT

The invention relates to a motor vehicle lock, in particular a motor vehicle door lock, which is provided with an actuation lever chain (2, 3, 4, 5, 8) having at least one locking lever (5) and an actuation lever (4). The lock is also provided with an electromagnet unit (6) that alternatively retains and releases the locking lever (5). According to the invention the lock also comprises a sensor (7) monitoring the electromagnet unit (6).

The invention relates to a motor vehicle lock, in particular a motor vehicle door lock, with an actuation lever chain with at least one locking lever and one actuation lever, and with an electromagnet unit which selectively holds and releases the latching lever.

Vehicle locks and in particular vehicle door locks are usually equipped with one or more electric motor drives in order to realize and implement different functional positions. These different functional positions are, for example, the positions “locked/unlocked”, “child-proof/child-resistant” or “theft-proof/theft-resistant”, which can generally be subsumed under the preamble “secured/unsecured” and are represented by the latching lever. Consequently, depending on the specific design, the latching lever can be a latching lever, a child safety lever, an anti-theft lever or a combination. This has proven to be fundamentally successful.

In the generic prior art according to DE 60 2004 007 638 T2, a motor vehicle lock is designed in such a manner that a remote control is realized. In detail, this involves realizing a locking mechanism, even if the actuation lever chain or a locking lever chain is blocked.

For this purpose, the known teaching proposes, among other things, a locking lever as a latching lever that can be manually transferred from its unlocked position to the locked position and back. In addition, the latching lever can be operated mechanically via a door knob. Finally, the possibility of electromechanical actuation using an electromagnet is also mentioned.

Such electromagnetic actuation of the latching lever requires that the latching lever is designed to be magnetizable, at least in the area of interaction with the electromagnet. In addition, the range of such electromagnets is limited with regard to positioning movements of the latching lever. For this reason, the electrical motor drives described above are predominantly used in practice to actuate the latching lever or, more generally, the levers of an actuation lever chain. This is because significant actuating movements of the lever to be actuated can often only be achieved with the aid of such electromotive drives. For this purpose, the electromagnetic drives already mentioned typically have an output disk and an actuating cam arranged on it.

With all the vehicle locks described above, and in particular vehicle door locks, the general problem is to protect the vehicle occupants in the event of an accident, for example, and to provide rescue personnel arriving at the scene with unhindered access to the interior of the vehicle. There are various solutions in the prior art that work with mass inertia elements, for example to block exterior door handles or to move a locked vehicle lock into its unlocked position in the event of a crash. The known procedures have generally proven themselves, but are often complex and leave room for improvements to their functionality.

With the help of the electromagnet realized in the generic prior art according to DE 60 2004 007 638 T2, it is generally possible to either hold and release the latching lever or to keep it in its “locked” position or to move it to the “unlocked” position. This is all achieved silently due to the acting magnetic holding forces and is therefore superior in terms of noise behavior to the familiar electric motor drives with output disk and actuating cams. However, the problem with such fuse units is that the exact state of the electromagnet unit is unknown. As a result, no direct information can be given about the position of the latching lever in the sense of “secured” or “unlocked”.

Typically, the latching lever is in its functional position “secured” in contact with the electromagnet or the electromagnet unit. In contrast, the “unlocked” position of the latching lever corresponds to the electromagnet not (or no longer) magnetically attracting the latching lever. These different functional positions cannot yet be checked in the prior art and transmitted to a control unit, for example. This is where the invention steps in.

The invention is based on the technical problem of further developing such a motor vehicle lock in such a manner that the functional status of the latching lever can be easily checked.

In order to solve this technical problem, a motor vehicle lock and in particular a motor vehicle door lock according to the invention is characterized in that a sensor checking the electromagnet unit is provided.

In an advantageous embodiment, the sensor is designed as a magnetic field sensor and, for example, a Hall sensor. This means that the sensor or magnetic field sensor can be used to check and detect the magnetic field generated by the electromagnet unit with regard to its basic existence and also with regard to its strength. For this purpose, the sensor is advantageously arranged in an interaction area of the latching lever with the electromagnet unit.

Placing the sensor in the area where the latching lever interacts with the electromagnet unit ensures that the sensor precisely detects the presence and also the strength of the magnetic field from the electromagnet unit in the area where the electromagnet or electromagnet unit can act on the latching lever.

Advantageously, the sensor is therefore set up both to detect the sound state of the electromagnet unit and to measure the magnetic field and is therefore capable of diagnosis. This means that the sensor can initially be used to detect the switching state of the electromagnet unit. In the simplest case, this corresponds to the electromagnet unit being switched on or off. The switched-on state may correspond to the latching lever, which can be magnetized at least in the area of interaction with the electromagnet or the electromagnet unit, being attracted by the electromagnet unit.

The additional option of diagnostics and magnetic field measurement by the sensor also means that the sensor can use the measured magnetic field to determine whether it is sufficient to actually hold the latching lever in contact with the electromagnet unit. Here, the invention is typically based on the realization that the latching lever is usually elastically coupled to an actuating lever, so that when the actuating lever is acted upon, forces act on the latching lever to remove it from the electromagnet unit.

Proper functionality is only guaranteed if the electromagnet or electromagnet unit generates a sufficient magnetic field to keep the latching lever in its “secured” position. Since the sensor or magnetic field sensor used according to the invention is advantageously set up not only to detect the switching state but also to measure the magnetic field, it can be used to check the switching state of the electromagnet unit as well as whether the magnetic field provided by the electromagnet unit is sufficient to hold the latching lever in contact with the electromagnet unit. This means that in addition to detecting the switching status, the sensor is also capable of diagnostics.

In this manner, a control unit connected to the sensor and supplied with corresponding sensor signals can be comprehensively informed about the respective status of the electromagnet unit and thus also that of the latching lever. As a result, for example, an error or fault signal is not only output if the electromagnet unit remains switched off or does not generate a magnetic field despite being energized, but also in the event that the magnetic field generated is not sufficient. This means that the latching lever assumes or can assume its “unlocked” state in the “on” switching state of the electromagnet unit. This provides the control unit with comprehensive information and allows a complete picture of the functional status of the vehicle lock in question to be compiled. These are the main advantages.

In an advantageous embodiment, the actuation lever chain is equipped with a coupling lever in addition to the latching lever, which interacts with the latching lever. For this purpose, it has proven useful for the coupling lever to be pivoted on the actuation lever, for example. As a result, if the actuation lever is actuated, the coupling lever, which is rotatably mounted on the actuation lever, is carried along during this process. Furthermore, as the latching lever typically has a driving contour that acts on the coupling lever, the coupling lever can be transferred to its “disengaged” position during this process.

This is because the latching lever and the actuation lever are also usually elastically coupled to one another. A spring and, in particular, a screw or reversible spring that elastically couples the two levers together is often used here. This allows the coupling lever to be engaged/disengaged in accordance with the electromagnet unit acting on the latching lever. The latching lever may be a locking lever. However, the latching lever can also be designed as a child safety lever or anti-theft lever. Combinations are also conceivable.

If the locking lever is in its “secured” position, the locking lever is applied to the electromagnet unit. The electromagnet unit is energized for this purpose and generates a magnetic field, which is used to attract the entire magnetizable locking lever or at least the magnetizable area of the locking lever in the area of interaction with the electromagnet.

If the actuation lever is now actuated in this “secured” position of the locking lever, the locking lever is still held in contact with the electromagnet unit with the aid of the electromagnet unit. As a result, the driving contour on the locking lever acting on the coupling lever can work on the coupling lever. Since the coupling lever, and thus the driving contour on the latching lever, is rotatably mounted on the actuation lever, a pivoting movement of the actuation lever relative to the stationary latching lever causes the coupling lever to be moved from its typical functional position “engaged” to the “disengaged” position.

As a result, the disengaged coupling lever cannot mechanically connect the actuation lever with an additionally provided release lever, so that a locking mechanism consisting substantially of a catch and pawl that can be acted upon with the aid of the release lever retains its closed position.

If, on the other hand, the electromagnet unit is switched off and releases the latching lever, the latching lever can move together with the actuation lever when the actuation lever is actuated. As a result of this, the coupling lever also remains in its “engaged” position and, in this manner, the actuation lever can work on the release lever via the engaged coupling lever so that, as a result of this, a pawl in engagement with a catch is lifted off in the locking mechanism's closed state with the aid of the release lever. The locking mechanism and an associated vehicle door are opened. These are the main advantages.

In the following, the invention is explained in more detail with the aid of a drawing showing only an exemplary embodiment; in the figures:

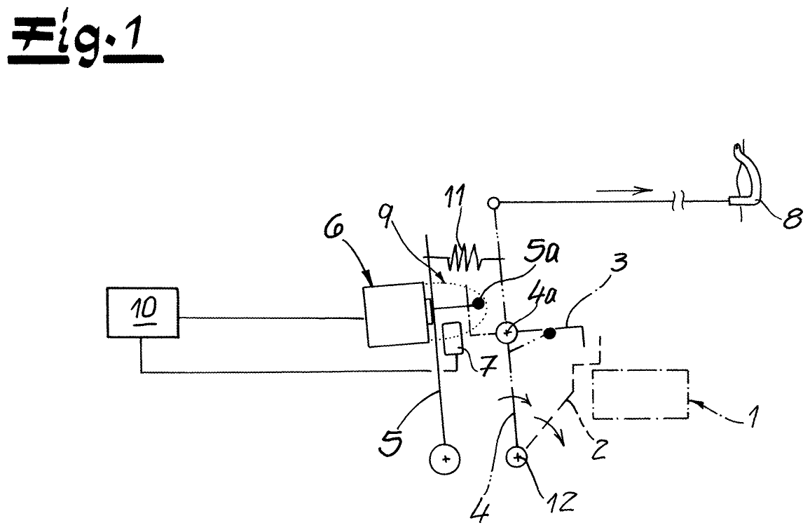

FIG. 1 shows the motor vehicle lock according to the invention in the “secured” state,

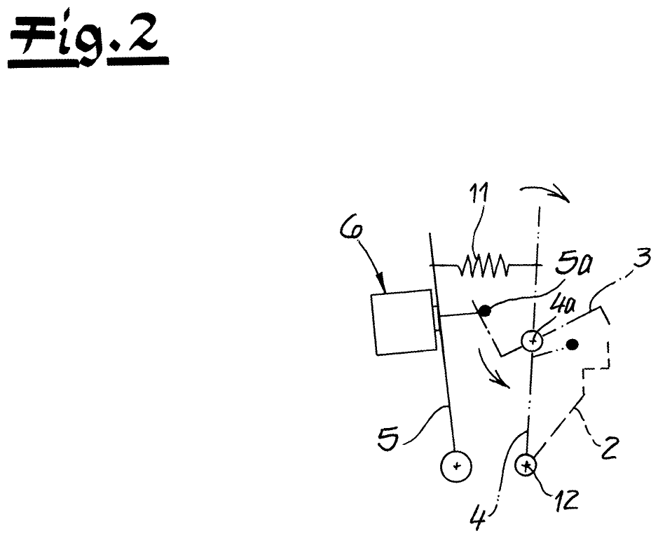

FIG. 2 shows the vehicle lock according to FIG. 1 in an actuated state and

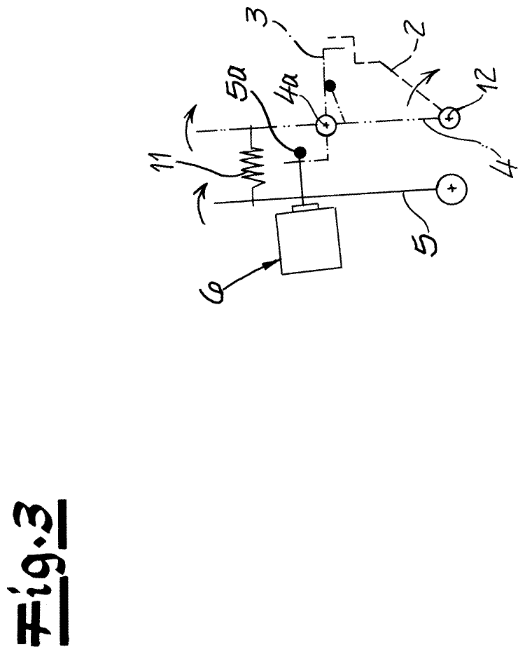

FIG. 3 shows the subject matter of FIG. 1 in the “unlocked” functional state.

The figures show a motor vehicle lock which, according to the exemplary embodiment, is designed as a motor vehicle door lock. For this purpose, the motor vehicle door lock initially has a merely indicated locking mechanism 1 and an actuation lever chain 2, 3, 4, 5. The actuation lever chain 2, 3, 4, 5 is equipped with at least one latching lever 5 and one actuation lever 4.

The illustration shows that in addition to the latching lever 5 and the actuation lever 4, a coupling lever 3 and a release lever 2 are also provided. The coupling lever 3 is rotatably mounted on the actuation lever 4. In the exemplary embodiment, the actuation lever 4 is an external actuation lever 4, which can be actuated by means of a handle 8 or an electric motor drive.

In addition, an electromagnet unit 6 is realized, which optionally holds and releases the latching lever 5. For this purpose, the latching lever 5 is designed to be magnetizable at least in an interaction area 9 with the electromagnet unit 6. As a rule, the latching lever 5 is designed to be magnetizable throughout, for example it can be designed as a lever made of (magnetizable) steel.

The electromagnet unit 6 is controlled via a control unit 10. In addition, according to the invention, a sensor 7 is realized which checks the electromagnet unit 6 and whose signals are also recorded by the control unit 10.

According to the exemplary embodiment, the sensor 7 is a magnetic field sensor, which is exemplarily designed as a Hall sensor. This means that a semiconductor chip operating according to the Hall effect is used as magnetic field sensor 7 at this point. For this purpose, the sensor or magnetic field sensor 7 is arranged in the interaction area 9 of the latching lever 5 with the electromagnet unit 6.

In this manner, both a switching state of the electromagnet unit 6 and a magnetic field measurement can be carried out using the sensor or magnetic field sensor 7. The switching state of the electromagnet unit 6 is generally the “on” and “off” states, which can be detected using the sensor or magnetic field sensor 7 and transmitted to the control unit 10. Furthermore, the sensor or magnetic field sensor 7 is also set up for magnetic field measurement and is therefore capable of diagnosis.

This means that the sensor or magnetic field sensor 7 arranged in the interaction area 9 can also be used to detect the strength of the magnetic field in the interaction area 9. The strength of the magnetic field can then be used to determine whether the latching lever 5 is held securely in contact with the electromagnet unit 6 or not when the electromagnet unit 6 is energized. This typically includes the “secured” state of the latching lever 5 in contact with the electromagnet unit 6.

However, if the electromagnet unit 6 is switched off, it releases the latching lever 5 and the latching lever 5 moves to its “unlocked” functional position. The same is the case if the strength of the magnetic field in the interaction area 9 is insufficient.

As previously explained, the actuation lever chain 2, 3, 4, 5 is equipped with a coupling lever 3 in addition to the latching lever 5, which interacts or can interact with the latching lever 5. For this purpose, the latching lever 5 has a driving contour 5a. The coupling lever 3 is rotatably mounted on the actuation lever 4. For this purpose, an axis of rotation 4a is provided on the actuation lever 4, which in the context of the exemplary embodiment and as described is an external actuation lever.

It can be seen that the latching lever 5 and the actuation lever 4 are elastically coupled to one another. For this purpose, a spring 11 elastically coupling the two levers 4, 5 to one another is realized, which in the exemplary embodiment is a helical spring or helical coil spring 11. In addition, the design is such that the coupling lever 3 is selectively engaged/disengaged in accordance with the electromagnet unit 6 acting on the latching lever 5, as will be explained in more detail below. The latching lever 5 can be a locking lever 5 as a whole. In general, the realization of a child safety lever or anti-theft lever as well as a combination is also possible and conceivable at this point.

The mode of operation is as follows. FIG. 1 shows the closed state of the locking mechanism 1. In its functional position “secured”, the latching lever 5 is in contact with the electromagnet unit 6 because the electromagnet unit 6 is energized. The energization of the electromagnet unit 6 and a sufficient magnetic field in the interaction area 9 to hold the latching lever 5 is detected by the sensor or magnetic field sensor 7 and transmitted to the control unit 10.

If now, starting from this functional position “secured” in FIG. 1 and in the closed state of the locking mechanism 1, the actuation lever or external actuation lever 4 is actuated with the aid of the handle 8, which corresponds to its clockwise movement about an axis 12 as indicated in FIG. 1, this clockwise movement of the actuation lever 4 about its axis 12 is in relation to the release lever 2 and thus also the locking mechanism 1 is empty. In fact, the actuation lever 4 and the release lever 2 are mounted on the same axis (see FIG. 2).

This is because when the actuation lever 4 is now acted upon clockwise about its axis 12, the latching lever 5 in its secured position ensures that the driving contour 5a can work on the coupling lever 3, which is mounted on the actuation lever 4 so that it can rotate about the axis 4a. In fact, compared to the illustration in FIG. 1, the coupling lever 3 is pivoted counterclockwise around its axis of rotation 7 or axis 4a, as shown in FIG. 2.

As a result of this, the coupling lever 3 moves from its “engaged” state shown previously and in FIG. 1 to the “disengaged” position. As a result, the actuation lever 4 together with the disengaged coupling lever 3 cannot act on the release lever 2, which is mounted coaxially to the actuation lever 4. This is because a corresponding contour of the coupling lever 3 runs past a counter contour of the release lever 2, as can be seen by comparing FIG. 1 with FIG. 2. As a result of this, the release lever 2 remains in its position and the movement of the actuation lever 4 as a whole also goes empty in relation to the locking mechanism 1, which consequently retains its closed state.

This means that the coupling lever 3 is disengaged when the latching lever 5 is in the “secured” position in accordance with the electromagnet unit 6 acting on the latching lever 5. As a result, when the actuation lever 4 is actuated about its axis 12, there is only a pivoting movement of the actuation lever 4 about the relevant axis 12, without the latching lever 5 being moved along. The spring 11 coupling the two levers 4, 5 is stretched during this process. The coupling lever 3 runs past the release lever 2 so that the locking mechanism 1 is not opened.

If, on the other hand, the electromagnet unit 6 is no longer energized, the latching lever 5 can no longer be held magnetically in contact with the electromagnet unit 6. This corresponds to a transition from the “secured” functional position of the latching lever 5 in contact with the electromagnet unit 6 as shown in FIGS. 1 and 2 to the “unlocked” functional position of the latching lever 5n as shown in FIG. 3.

Since the latching lever 5 is therefore not (or no longer) held in place by the electromagnet unit 6, a renewed clockwise actuation of the actuation lever 4 about its axis 12 results in the latching lever 5 being entrained during this process. This is ensured by the spring 11, which elastically couples the two levers 4, 5 together and is not deflected during this process. As there is consequently also no relative movement between the coupling lever 3 and the latching lever 5 or its driving contour 5a in this case, the coupling lever 3 remains “engaged” in the position shown in FIG. 1. This allows the engaged coupling lever 3 to work with its contour on the counter contour on the release lever 2 and causes the actuation lever 4 to be moved clockwise around the axis 12 so that the release lever 2 is also pivoted clockwise around the common axis 12 during this process.

The pivoting movement of the release lever 2 around the axis 12 in a clockwise direction has the effect that, with the aid of the release lever 2, a pawl not expressly shown as a component of the locking mechanism 1 is lifted from a catch also provided at this point with regard to its latching engagement in the closed state of the locking mechanism 1. Accordingly, the catch can open spring-assisted and releases a previously trapped locking bolt. An associated vehicle door is also released in this manner.

The transition from the “locked” position of the latching lever as shown in FIG. 1 to the “unlocked” position as shown in FIG. 2, which also allows the locking mechanism 1 to be opened, can be brought about either by the control unit 10 or, for example, by a failure of the power supply to the electromagnet unit 6. The latter possibility may correspond to an accident or a “crash”. Since in this case the latching lever 5, which is designed as a locking lever, leaves its “secured” or “locked” position, the motor vehicle lock shown is automatically transferred to its “unlocked” or “unlocked” state following such a crash and can therefore still be opened from the outside via the handle 8 using the actuation lever or external actuation lever 4 in the example case. This corresponds to a “crash unlock” function sequence, which is expressly desired.

This is because typically and during the operation of a motor vehicle, the motor vehicle lock or motor vehicle door lock shown assumes its “secured” or “locked” position. This lock can now be released either specifically with the help of the control unit 10, for example, or by interrupting the electrical energy supply to the electromagnet unit 6 as described. In both cases, the latching lever 5 moves from its “secured” or “locked” position to the unlocked or unlocked position with the consequences described above.

### LIST OF REFERENCE SIGNS

locking mechanism 1
actuation lever chain 2, 3, 4, 5
coupling lever 3
actuation lever 4
axis of rotation 4a
latching lever 5
driving contour 5a
electromagnet unit 6
magnetic field sensor 7
handle 8
interaction area 9
control unit 10
spring 11
helical coil spring 11

1. A motor vehicle lock comprising:
an actuation lever chain comprising at least one latching lever and an actuation lever,
an electromagnet unit configured to selectively holds and releases the latching lever, and
a sensor configured to check and detect existence and strength of a magnetic field generated by the electromagnet unit.

2. The motor vehicle lock according to claim 1, wherein the sensor is designed as a magnetic field sensor.

3. The motor vehicle lock according to claim 1, wherein the sensor is arranged in an interaction area of the latching lever with the electromagnet unit.

4. The motor vehicle lock according to claim 1, wherein the sensor is configured to detect the switching state of the electromagnet unit and to measure the magnetic field and is thus capable of diagnosis to determine whether the magnetic field is sufficient to hold the latching lever in contact with the electromagnet unit.

5. The motor vehicle lock according to claim 1, wherein the actuation lever chain further comprises a coupling lever interacting with the latching lever.

6. The motor vehicle lock according to claim 5, wherein the coupling lever is rotatably mounted on the actuation lever.

7. The motor vehicle lock according to claim 5, wherein the latching lever has a driving contour acting on the coupling lever.

8. The motor vehicle lock according to claim 1, wherein the latching lever and the actuation lever are elastically coupled to one another by a spring.

9. The motor vehicle lock according to claim 1, wherein the coupling lever is engaged/disengaged in accordance with the electromagnet unit acting on the latching lever.

10. The motor vehicle lock according to claim 1, wherein the latching lever is designed as a locking lever.

11. The motor vehicle lock according to claim 1 further comprising a control unit, wherein the electromagnet unit is controlled by the control unit.

12. The motor vehicle lock according to claim 11 wherein, the sensor is configured to transmit signals indicating the status of the electromagnet unit to the control unit.

13. The motor vehicle lock according to claim 11, wherein the control unit is configured to record signals from the sensor.

14. The motor vehicle lock according to claim 1, wherein the actuation lever chain further comprises a release lever mounted coaxially to the actuation lever.

15. The motor vehicle lock according to claim 1 wherein the latching lever is magnetizable in the interaction area with the electromagnet unit.

16. The motor vehicle lock according to claim 5 wherein the actuation lever comprises an axis of rotation, wherein the coupling lever is configured to move about the axis of rotation.
